(19) United States
(12) Patent Application Publication
(10) Pub. No.: US 2014/0172484 A1
(43) Pub. Date: Jun. 19, 2014

(54) ELECTRONIC DEVICE AND WORK HANDOVER METHOD

(71) Applicant: YongMing Technology Consulting Corp., New Taipei (TW)

(72) Inventors: LI LIU, New Taipei (TW); KUO-FENG WANG, New Taipei (TW); HUA-YANG LIN, New Taipei (TW)

(73) Assignee: YONGMING TECHNOLOGY CONSULTING CORP., New Taipei (TW)

(21) Appl. No.: 14/108,354

(22) Filed: Dec. 17, 2013

(30) Foreign Application Priority Data
Dec. 17, 2012 (TW) 101147941

(51) Int. Cl. G06Q 10/06

(52) U.S. Cl. CPC G06Q 10/063116
USPC 705/7.16

(57) ABSTRACT

An electronic device connects to a cloud server. The cloud server stores information of a first worker and a second worker. The second worker does work handover with the first worker. When it is time to do work handover by the second worker, the second worker uses the electronic device to touch the electronic device of the first worker. The information of the second worker of the electronic device is compared with the information of the second worker stored in the cloud server. When the information of the electronic device is the same as the information stored in the cloud server, a display device connected to the cloud server displays job contents stored in the cloud server.

### BACKGROUND

1. Technical Field

Embodiments of the present disclosure relate to work management technology, and more particularly to an electronic device and a work handover method.

2. Description of Related Art

Around the clock jobs need people working in shifts. During shift change, a transfer or handover may need to take place. For example, these types of jobs may be performed by doctors and nurses or workers on production lines. When the workers want to do handover, the workers have to confirm transfer contents manually, which is time-consuming.

### BRIEF DESCRIPTION OF THE DRAWINGS

FIG. 1 is a block diagram of one embodiment of an electronic device including a handover system.

FIG. 2 is a block diagram of one embodiment of function modules of the handover system in FIG. 1.

FIG. 3 is a flowchart of one embodiment of a work handover method.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage system. Some non-limiting examples of non-transitory computer-readable media include CDs, DVDs, BLU-RAY, flash memory, and hard disk drives.

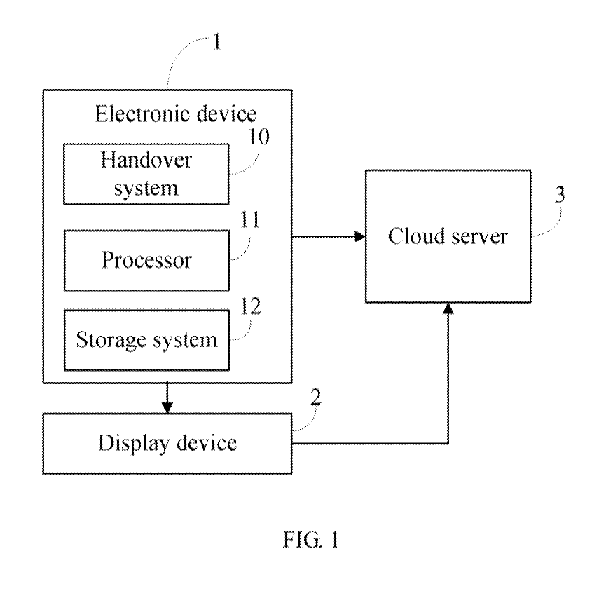

FIG. 1 is a block diagram of one embodiment of an electronic device 1. The electronic device 1 includes a handover system 10, a processor 11, and a storage system 12. In one embodiment, the electronic device 1 may be a mobile phone, for example. The electronic device 1 has a function of wireless communication. The wireless communication may be near field communication (NFC), WI-FI, for example. A first worker and a second worker are assigned to be responsible for a work detail. The work detail completed is transferred to the second worker from the first worker. The first worker uses the electronic device 1 to complete transferred contents of the work detail before passing the electronic device 1 to the second worker. The storage system 12 stores information of the first worker and the second worker. The information may include a name, a work identification of each worker, for example.

The electronic device 1 connects to a display device 2 and a cloud server 3. The display device 2 may be a computer, a smart television, an electronic white-board, for example. The cloud server 3 stores a working schedule of the first worker and the second worker, identification data of the first worker and the second worker, job contents of the first worker and the second worker, and the like. The working schedule includes work times of the first worker and the second worker, and information of the first worker and the second worker. The identification data of the first worker and the second worker may be fingerprints, facial recognition, voiceprint recognition, for example.

The electronic device 1 controls the display device 2 to access the cloud server 3 and display the contents stored in the cloud server 3. For example, in a hospital, two doctors are doing work handover (e.g., from a first doctor to a second doctor). The display device 2 displays information of patients for the second doctor.

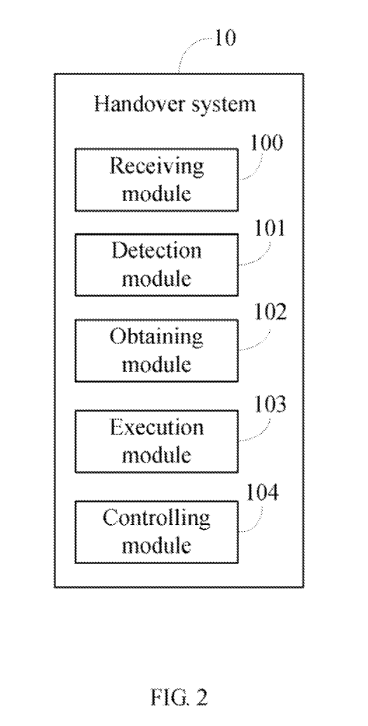

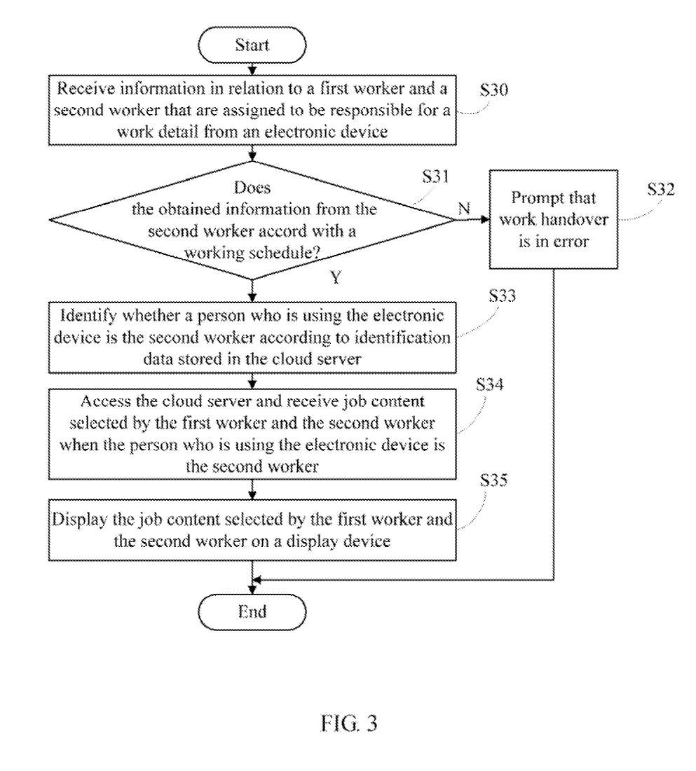

As shown in FIG. 2, the handover system 10 includes a plurality of function modules, such as a receiving module 100, a detection module 101, an obtaining module 102, an executing module 103, and a controlling module 104. The modules 100-104 include computerized code in the form of one or more programs that are stored in the storage system 12. The computerized code includes instructions that are executed by the processor 11, to provide functions of the handover system 10. Detailed functions of the modules 100-104 are given in reference to FIG. 3.

FIG. 3 is a flowchart of one embodiment of a work handover method. Depending on the embodiment, additional steps may be added, others removed, and the ordering of the steps may be changed.

In step S30, the receiving module 100 receives information in relation to a first worker and a second worker that are assigned to be responsible for a work detail from the electronic devices 1. In one embodiment, the receiving module 100 receives the information by using the NFC of the electronic devices 1 of the first worker and the second worker. The first worker can use the electronic device 1 to touch the electronic device 1 of the second worker to receive the information of each other. In another embodiment, when the second worker is at a remote location, a client device with the NFC connected with the cloud server 3 is provided. The second worker can touch the client device so that the cloud server 3 can obtain the information of the second worker via the client device.

In step S31, the detection module 101 accesses the cloud server 3 and detects whether the obtained information from the second worker accords with the working schedule. When the obtained information does not accord with the working schedule, step S32 is implemented. When the obtained information does accord with the working schedule, step S33 is implemented.

In step S32, the detection module 101 prompts that the work handover is in error. Then the procedure ends.

In step S33, the obtaining module 102 identifies whether a person who is using the electronic device 1 is the second worker according to the identification data stored in the cloud server 3.

In step S34, when the person who is using the electronic device 1 is the second worker, the execution module 103 accesses the cloud server 3 and receives job contents selected by the first worker and the second worker. In one embodiment, the execution module 103 provides a list which lists a plurality of job contents. The first worker and the second worker can select the job contents from the list.

In step S35, the controlling module 104 controls the display device 2 to access the cloud server 3. The display device 2 displays the job contents selected by the first worker and the second worker. In one embodiment, the first worker and the second worker can edit the job contents on the display device 2. The editing of the job contents may be adding job contents, deleting job contents, or modifying job contents, for example. The first worker can edit the job contents on the display device 2 besides the first worker. The second worker can edit the job contents on another display device 2 near to the second worker. The display device 2 can communicate with the another display device 2 to show the job contents edited by the first worker and the second worker.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a processor; and
a non-transitory computer-readable medium that stores one or more programs, which comprise instructions which when executed by the processor of the electronic device, performs operations of:
(a) receiving information in relation to a first worker and a second worker that are assigned to be responsible for a work detail from the electronic device;
(b) accessing job contents stored in a cloud server connected with the electronic device when the information of the second worker accords with a working schedule stored in the cloud server; and
(c) controlling a display device to access the cloud server and to display the job contents on the display device.

2. The electronic device as claimed in claim 1, wherein before operation (b) the operations further comprise:
identifying whether a person who is using the electronic deice of the second worker is the second worker according to identification data stored in the cloud server when the information of the second worker accords with the working schedule.

3. The electronic device as claimed in claim 1, wherein the working schedule comprises work times of the first worker, the work times of the second worker, information of the first worker and the second worker.

4. The electronic device as claimed in claim 1, wherein the information of the first worker and the second worker comprises names of the first worker and the second worker, work identification of the first worker and the second worker.

5. The electronic device as claimed in claim 1, wherein the operations further comprise:
prompting that the work handover is in error when the information of the second worker is not according with the working schedule.

6. A method being executed by a processor of an electronic device, comprising steps:
(a) receiving information in relation to a first worker and a second worker that are assigned to be responsible for a work detail from the electronic device;
(b) accessing job contents stored in a cloud server connected with the electronic device when the information of the second worker accords with a working schedule stored in the cloud server; and
(c) controlling a display device to access the cloud server and to display the job contents on the display device.

7. The method as claimed in claim 6, wherein before step (b) the method further comprises:
identifying whether a person who is using the electronic deice of the second worker is the second worker according to identification data stored in the cloud server when the information of the second worker accords with the working schedule.

8. The method as claimed in claim 6, wherein the working schedule comprises work times of the first worker, the work times of the second worker, information of the first worker and the second worker.

9. The method as claimed in claim 6, wherein the information of the first worker and the second worker comprises names of the first worker and the second worker, work identification of the first worker and the second worker.

10. The method as claimed in claim 6, further comprising:
prompting that the work handover is in error when the information of the second worker is not according with the working schedule.

11. A non-transitory computer-readable medium having stored thereon instructions that, when executed by a processor of an electronic device, cause the processor to perform operations of:
(a) receiving information in relation to a first worker and a second worker that are assigned to be responsible for a work detail from the electronic device;
(b) accessing job contents stored in a cloud server connected with the electronic device when the information of the second worker accords with a working schedule stored in the cloud server; and
(c) controlling a display device to access the cloud server and to display the job contents on the display device.

12. The non-transitory computer-readable medium as claimed in claim 11, wherein before operation (b) the operations further comprise:
identifying whether a person who is using the electronic deice of the second worker is the second worker according to identification data stored in the cloud server when the information of the second worker accords with the working schedule.

13. The non-transitory computer-readable medium as claimed in claim 11, wherein the working schedule comprises work times of the first worker, the work times of the second worker, information of the first worker and the second worker.

14. The non-transitory computer-readable medium as claimed in claim 11, wherein the information of the first worker and the second worker comprises names of the first worker and the second worker, work identification of the first worker and the second worker.

15. The non-transitory computer-readable medium as claimed in claim 11, wherein the operations further comprise:
prompting that the work handover is in error when the information of the second worker is not according with the working schedule.
